(19) United States
(12) Patent Application Publication
(10) Pub. No.: US 2014/0328625 A1
(43) Pub. Date: Nov. 6, 2014

(54) BITUMEN CUTBACK AGENTS

(71) Applicant: TECHNIX INDUSTRIES LIMITED, New Plymouth (NZ)

(72) Inventors: John Brodie Matthews, New Plymouth (NZ); Philip Anthony Charles Jennings, New Plymouth (NZ); Lijin Kuriachan, New Plymouth (NZ); Philip Raymond Herrington, Lower hutt (NZ)

(21) Appl. No.: 14/358,957

(22) PCT Filed: Nov. 16, 2012
(86) PCT No.: PCT/NZ2012/000212

§ 371 Date: May 16, 2014

(30) Foreign Application Priority Data
Nov. 16, 2011 (NZ) 596463

(51) Int. Cl. C08J 3/09; E01C 7/18; C08L 95/00

(52) U.S. Cl. CPC C08J 3/095; C08L 95/00; E01C 7/182; C08J 2395/00; C08L 2555/62; C08L 2555/28; C08L 2555/32
USPC 404/75; 106/311; 106/278

(57) ABSTRACT

Bitumen cutback agents include esters, preferably methyl esters in the range C6 to C14, preferably C8 to C12. The methyl esters may be sourced from organic oils, such as coconut or palm kernel oil. The cutback agent shows improved performance over prior cutback agents such as kerosene.

### FIELD OF THE INVENTION

The invention relates to bitumen cutback agents, in particular to the use of fatty acid esters as bitumen cutback agents. These bitumen cutback agents may also be described as cutters, cutback additives, bitumen solvents, or bitumen thinners.

### BACKGROUND TO THE INVENTION

Bitumen is a viscoelastic mix of hydrocarbons used to hold together aggregates in pavements. It is a highly viscous waterproof adhesive at ambient temperatures. Bitumen is generally sourced as a fraction from the distillation of crude oil, but may also be found in natural deposits. One way to use bitumen in road pavements is to spray the bitumen at elevated temperatures onto the road pavement substrate and then to apply stone chips (generally single sized aggregates) to the bitumen surface. This is variously known as bitumen spray sealing, bitumen seal coating, chip sealing or surface dressing. This can be contrasted with “hot-mix” or asphaltic concrete applications where bitumen and the aggregate are mixed together and then applied to a substrate. In cold-mix (or plant-mix) applications highly cutback bitumen and aggregate are mixed together at ambient temperatures and then applied to a substrate.

In many countries kerosene and other volatile petroleum derived products are added as a “cutter” or “cutback agent” to bitumen to reduce (or “cutback”) the viscosity of the bitumen. The mixture obtained may be called “cutback bitumen”.

The reduction in viscosity of the bitumen aids the construction of seal coats in road pavements as the softened mixture wets the chips more easily. The cutback agent evaporates from the seal coat, the cutback agent becoming a negligible component of the seal coat a few months after application. If significant amounts of the cutback agent remain in the seal coat an unwanted long term softening effect may result.

Cutback agents are also used to lower the viscosity of bitumen when it is applied as a primer to the surface of a road pavement aggregate basecourse or substrate. The primer penetrates into the surface of the basecourse and provides a more “bitumen friendly” surface. Improved adhesion to the basecourse of a subsequently applied seal coat or “hot mix” is obtained. The primer may also serve to assist in waterproofing the basecourse layer.

Kerosene is used as a bitumen cutback agent at different concentrations according to local conditions and requirements. In New Zealand cutback bitumen for use in bitumen spray sealing or bitumen seal coating typically contains 2 to 5% (w/w) of kerosene. In cutback bitumen for use as a primer 10 to 15% (w/w) of kerosene may be used.

There are several disadvantages associated with this use of kerosene for bitumen cutbacks. For example, the cutback bitumen is hazardous in use. Spray sealing or seal coating at 150° C. to 165° C. is well above the flashpoint of the cutback bitumen. In addition, evaporation of kerosene into the atmosphere is environmentally harmful. It is estimated that around 2000 to 4000 tonnes of kerosene is released into the environment each year in New Zealand alone. The odours emanating from the cutback bitumen are unpleasant and the kerosene is derived from a non-renewable resource.

In order to address these disadvantages of conventional bitumen cutback agents, it is possible to use bitumen-water emulsions. After spray-application to the substrate the emulsion breaks and the water evaporates or runs off the surface. However, this process happens slowly (especially in cold weather or in shaded areas) and the applied bitumen emulsion is vulnerable to wet weather until the emulsion has broken. If heavy rain falls shortly after application and before the emulsion has broken the emulsion can be washed from the road surface. This causes further expense through the need to relay the surface. It also causes environmental damage as the bitumen is washed away and enters waterways.

Extender oils (commonly known as fluxes) and waxes are also used in bitumen spray sealing and “hot-mix” applications. Extender oils and waxes are distinct from cutback agents. Extender oils and waxes are used to modify the mechanical properties of the applied bitumen layer for extended periods of time, up to the life of the pavement in some applications. Extender oils and waxes remain as a component of the bitumen following application and setting of the seal coat or hot mix. The extender oils or waxes may simply solidify within the bitumen as the bitumen sets or may become cross-linked. Catalysts may be used to promote crosslinking. However, these catalysts may also promote oxidation of the bitumen and an undesirable hardening. In some applications it is desirable to produce a seal coat with softer bitumen. Extender oils and waxes can be used for this purpose because they remain in the bitumen after the application and setting of the seal coat or hot mix.

It is an object of the invention to provide an improved bitumen cutback agent, or at least to provide the public with a useful choice.

### SUMMARY OF THE INVENTION

In a first aspect the invention provides a bitumen cutback agent including lower alkyl esters of shorter chain length fatty acids.

Preferably, the shorter chain length fatty acids are predominantly C₈₋₁₄ fatty acids. More preferably, the shorter chain length fatty acids are predominantly C₈₋₁₂ fatty acids.

Preferably, the lower alkyl esters of shorter chain length fatty acids are C₁₋₃ alkyl esters of shorter chain length fatty acids. More preferably, the lower alkyl esters of shorter chain length fatty acids are methyl esters of shorter chain length fatty acids.

Preferably, the shorter chain length fatty acids are predominantly saturated fatty acids. More preferably, the lower alkyl esters of shorter chain length fatty acids consist predominantly of methyl esters of the following formulae: CH₃(CH₂)₄COOCH₃; CH₃(CH₂)₆COOCH₃; CH₃(CH₂)₈COOCH₃; CH₃(CH₂)₁₀COOCH₃, and CH₃(CH₂)₁₂COOCH₃. More preferably, the lower alkyl esters of shorter chain length fatty acids consist predominantly of methyl esters of the following formulae: and CH₃(CH₂)₆COOCH₃; CH₃(CH₂)₈COOCH₃; and CH₃(CH₂)₁₀COOCH₃. Most preferably, the lower alkyl esters of shorter chain length fatty acids consist predominantly of methyl esters of the formulae CH₃(CH₂)₈COOCH₃ and CH₃(CH₂)₁₀COOCH₃.

Preferably the lower alkyl esters of shorter chain length fatty acids consist predominantly of esters where the lower alkyl and fatty acid groups together comprise less than 16 carbon atoms. More preferably the lower alkyl esters of shorter chain length fatty acids consist predominantly of esters where the lower alkyl and fatty acid groups together comprise less than 15 carbon atoms. Still more preferably the lower alkyl esters of shorter chain length fatty acids consist predominantly of esters where the lower alkyl and fatty acid groups together comprise less than 14 carbon atoms.

Preferably, the lower alkyl esters of shorter chain length fatty acids are derived from non-mineral sources. More preferably, the lower alkyl esters of shorter chain length fatty acids are derived from non-mineral plant sources. Most preferably, the lower alkyl esters of shorter chain length fatty acids are derived from coconut oil or palm kernel oil.

In a first embodiment of the first aspect the invention provides a bitumen cutback agent including esterified or transesterified coconut oil fatty acids or coconut oil fatty acid derivatives.

In a second embodiment of the first aspect the invention provides a bitumen cutback agent including esterified or transesterified palm kernel oil fatty acids or palm kernel oil fatty acid derivatives.

In either of these first and second embodiments of the first aspect, preferably the fatty acids are refined, or the esterified or transesterified fatty acids or fatty acid derivatives are refined, to reduce a level of esters of longer chain fatty acids in the cutback agent.

In a second aspect the invention provides the use in a method of bitumen seal coating of a bitumen cutback agent of the first aspect of the invention.

In a third aspect the invention provides the use in a method of cold mix application of a bitumen cutback agent of the first aspect of the invention.

In a fourth aspect the invention provides a cutback bitumen composition including bitumen and a bitumen cutback agent according to the first aspect of the invention.

In a fifth aspect the invention provides a method of temporarily reducing the viscosity of bitumen including the step of adding to bitumen a cutback agent according to the first aspect of the invention.

In a sixth aspect the invention provides a method of applying bitumen to a substrate including the steps of adding a bitumen cutback agent according to the first aspect of the invention to the bitumen and applying the cutback bitumen to the substrate.

In a seventh aspect the invention provides a method of forming a pavement surface including the steps of: adding a bitumen cutback agent according to the first aspect of the invention to bitumen; applying the cutback bitumen to a substrate; and then applying aggregate onto the cutback bitumen applied to the substrate.

In an eighth aspect the invention provides the use of lower alkyl esters of shorter chain length fatty acids as bitumen cutback agents.

In this specification the term “cutback agent” or “cutback additive” refer to substances used to achieve a short-term reduction in viscosity and to evaporate from the bitumen after application. The term “shorter chain length fatty acid” refers to a fatty acid of length less than C16. The term “organic source” indicates that the esters are obtained by processing of organic oils or other organic substances. For the purposes of this specification, substances from mineral sources (e.g. crude oil) or substances derived from mineral sources are not to be considered from an “organic source”. The term “predominantly” will be understood in the sense of “a substantial portion”, i.e. greater than 50% (w/w). Where reference is made to a number of carbon atoms, e.g. C12, of a fatty acid ester the number corresponds to the number of carbons comprised in the fatty acid of the ester. The terms “first”, “second”, “third”, etc. used with reference to elements, features or integers of the subject matter defined in the Summary of Invention or when used with reference to alternative embodiments of the invention are not intended to imply an order of preference. Reference to any publications or use in this specification does not constitute an admission that such publication or use is necessarily prior art, forms part of the common general knowledge, or is information that the skilled person would have ascertained before the earliest date to which the claims may be entitled.

### BRIEF DESCRIPTION OF THE DRAWINGS

FIG. 1 is a graph illustrating the evaporation rates for bitumen cutback agents.

### DESCRIPTION OF PREFERRED EMBODIMENTS

The invention resides in the use of lower alkyl esters of shorter chain fatty acids as bitumen cutback agents (also known as cutters). The shorter chain fatty acids are predominantly saturated fatty acids. The use is to be distinguished from the use of fatty acid esters as defined and described in the publication of Dean (2006). The fatty acid esters used in the method described in that publication are comprised of a carbon number greater than 20 and more preferably, greater than 40. These fatty acid esters are used in a binder that allows asphalt products to be produced at lower temperatures while retaining the mechanical properties of the asphalt product. By contrast, the lower alkyl esters of shorter chain fatty acids of the bitumen cutback agent of the invention do not contribute to the mechanical properties of the end-product. Similarly, the use of lower alkyl esters of shorter chain fatty acids is to be distinguished from the use of fatty acid esters of natural origin as described in the publications of Pasquier (2000) and Deneuvilliers and Hoang (2008). The fatty acid esters used in the methods described in these publications are functionalised to permit crosslinking and retention of the binder or fluxing oil as a component of the product. In the method of the present invention the lower alkyl esters of the shorter chain fatty acids are transient components of the applied bitumen.

The invention will now be described with reference to certain embodiments, which are discussed by way of example only.

The Applicant's invention provides the use of lower alkyl esters of fatty acids as cutback agents to be blended with bitumen. The lower alkyl esters are most advantageously fatty acid methyl esters. The fatty acid methyl esters are most advantageously derived from organic sources such as vegetable oils, in particular coconut and/or palm kernel oils. The skilled reader will understand that palm kernel oil is a different oil to palm oil, being derived from the kernel rather than the fruit pulp of the oil palm.

Around 80% of fatty acids from coconut oil are in the desired range of C6 to C14, with around 60% of fatty acids from coconut oil in the preferred range of C8 to C12. Around 70% of fatty acids from palm kernel oil are in the desired range of C6 to C14, with around 50% of fatty acids from palm kernel oil in the preferred range of C8 to C12. Proportions are shown in detail in Table 1:

TABLE 1
Fatty acid composition of coconut and palm
kernel oils (% of total fatty acids)

| | Coconut Oil | Palm kernel oil |
|---|---|---|
| C6 | 1% | — |
| C8 | 8% | 3% |
| C10 | 6% | 4% |
| C12 | 47% | 48% |
| C14 | 18% | 16% |
| C16 | 9% | 8% |

The inventors have also found that the quantities of oils in coconuts and palm kernels in the range C8 to C12 are very high compared to many other natural oils such as are contained in soya beans, canola, rape seed etc, or as are contained in animal fats.

In addition to the C6 to C14 (preferably C8 to C12) methyl esters, other short chain esters may also be used. For example, C13 and C5-C7 fatty acids are not found in significant levels in coconut or palm oil. These fatty acids are less common but are available from other plant or animal sources or by manufacture from crude oil or by-products of other chemical processes. Esters derived from such fatty acids may be added to the Applicant's methyl ester blend.

The methyl esters may be produced by known esterification or transesterification processes. For example a known esterification or transesterification process may be performed on coconut oil, or palm kernel oil, or on a blend of coconut and palm kernel oils, or derivatives of those oils. Suitable processes will be apparent to the skilled reader.

Preferably methyl esters with long chain lengths will not be present at significant levels in the final methyl ester blend. As is clear from Table 1, both coconut and palm kernel oils include significant amounts of C16 fatty acids. These may be excluded before esterification by appropriate processing of the oils to exclude the long chain fatty acids, or after esterification by appropriate processing of the methyl esters to exclude the long chain esters. Suitable processes (e.g. distillation) will be apparent to the skilled reader.

In preferred cutback agents, regardless of whether methyl or other lower alkyl esters are used, the esters consist predominantly of esters where the lower alkyl and fatty acid groups together comprise less than 16 carbon atoms. More preferably the esters consist predominantly of esters where the lower alkyl and fatty acid groups together comprise less than 15 carbon atoms. Still more preferably the esters consist predominantly of esters where the lower alkyl and fatty acid groups together comprise less than 14 carbon atoms.

The Applicant's cutback agent is considerably safer to use than prior agents such as kerosene because of its inherently higher flashpoint—the flashpoint for a 10% mixture in bitumen is compared to that for the same concentration of kerosene in Table 2. The Applicant's cutback agent is therefore much safer for machine operators to use for bitumen spray sealing.

TABLE 2
Flashpoints (Pensky - Marten closed cup, ASTM D93)

| Specimen | Flashpoint (° C.) |
|---|---|
| 10% Applicant's methyl ester | 124 |
| blend in Class 170 bitumen | |
| 10% kerosene blend in Class 170 bitumen | 79 |

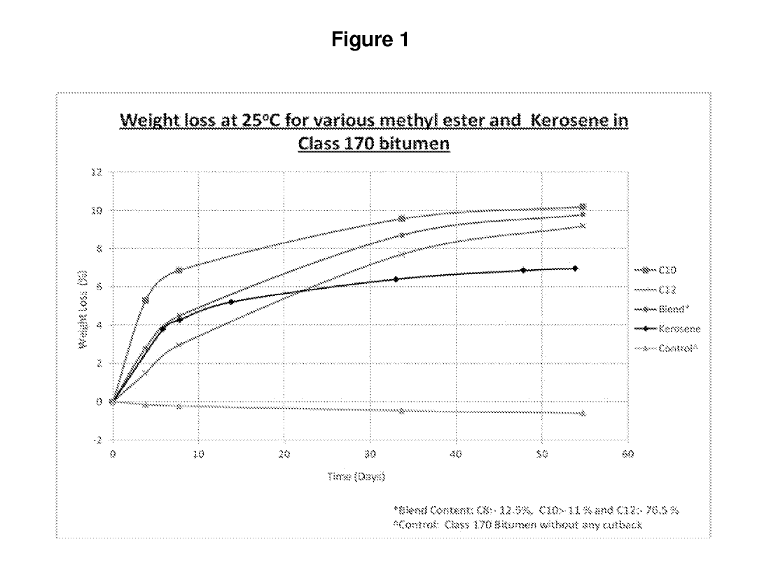

Tables 3 and 4, and FIG. 1 are results of 54 day test runs. Samples were prepared using Class 170 Bitumen: a control sample of bitumen without any cutback agent; bitumen cutback with kerosene; bitumen cutback with C10 methyl ester; bitumen cutback with C12 methyl ester; and bitumen cutback with a methyl ester blend. The methyl ester blend included 12.5% C8 methyl ester; 11% C10 methyl ester and 76.5% C12 methyl ester. All cutback samples were cut back with 10% cutback agent by weight.

1 mm films of each sample was prepared and held at 25° C. for the duration of the test.

TABLE 3
Evaporation Test with kerosene (1 mm films at 25° C. for 54 days)

| | Viscosity (Pas) at | | |
|---|---|---|---|
| | 25° C. (0.005 s⁻¹) | | Ratio |
| Specimen | Initial | Final | (final/initial) |
| Control (Class 170 bitumen)* | 209900 | 470300 | 2.24 |
| 10% wt kerosene | 669 | 263800 | 395 |

| | |
|---|---|
| Ratio of initial viscosities | 313 |
| (solvency effect) | |

*According to AS2008

TABLE 4
Evaporation Test with C8-C12 fatty acid methyl
ester blend (1 mm films at 25° C. for 54 days)

| | Viscosity (Pas) at | | |
|---|---|---|---|
| | 25° C. (0.005 s⁻¹) | | Ratio |
| Specimen | Initial | Final | (final/initial) |
| Control (Class 170 bitumen)* | 237200 | 370400 | 1.56 |
| 10% methyl ester blend | 379 | 134000 | 353 |

| | |
|---|---|
| Ratio of initial viscosities | 625 |
| (solvency effect) | |

*According to AS2008

The Applicant's cutback agent also provides more effective solvency than prior agents such as kerosene. This is achieved as a result of requiring less methyl ester cutback agent to produce the same reduction in viscosity, as indicated by the ratio of initial viscosities in Tables 3 and 4—i.e. the ratio of initial viscosities (solvency effect) for kerosene is 313 compared to 625 for the methyl ester blend.

Therefore less cutback agent may be used to achieve the same viscosity reduction than when kerosene is used.

This solvency benefit is achieved and maintained due to the Applicant's methyl ester blend having a comparable recovery of viscosity as can be seen in Tables 3 and 4—the final/initial ratio (which shows viscosity recovery) of the methyl ester blend is 353 compared to 395 for kerosene.

More of the Applicant's cutback agent evaporates from the bitumen, compared to kerosene, over the same timeframes. This is illustrated in FIG. 1.

The control sample lost no weight over the 54 day test. The kerosene cutback sample lost weight quickly over the first five days before evaporation slowed. The kerosene sample shows the lowest total weight loss of the four cutback samples at the end of the 54 day test period.

The three methyl ester cutback samples show significantly improved performance, all having greater weight loss at the end of the test period. The C10 cutback shows very rapid evaporation in the first week, while the blend cutback shows evaporation comparable to kerosene over the first week, but superior evaporation thereafter.

The Applicant's cutback agent therefore results in faster bitumen hardening (while still maintaining an acceptable hardening timeframe for bitumen spray sealing applications) and less unwanted long term or permanent softening.

Furthermore, the Applicant's cutback agent is biodegradable. This is a significant advantage over prior cutback agents such as kerosene. Any cutback agent leaching from the bitumen or evaporating will therefore biodegrade such that the environmental impact of the cutback agent is significantly reduced. Biodegradation occurs over a much shorter timeframe than for kerosene.

The Applicant's cutback agent also comes from a renewable resource—the methyl esters are derived from a renewable crop. In contrast kerosene is distilled from crude oil. Again, the Applicant's cutback agent therefore has much reduced environmental impact.

The Applicant's cutback agent may be used for purposes other than roadmaking, including for example making bitumen paints, and bitumen products for sealing, coating, lining, roofing etc.

The Applicant's cutback agent may be used for all grades of bitumen, both for roading applications such as those used for chip sealing, cold mix application and for non-roading applications such as pipe coatings, roofing systems etc.

The Applicant's cutback agent may be used with all forms of bitumen, including for example straight run, air blown or solvent precipitated bitumen (or mixtures thereof) in liquid form or as an emulsion in water.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

### REFERENCES

Pasquier (2000) U.S. Pat. No. 6,156,113
Deneuvilliers and Hoang (2008) U.S. patent application Ser. No. 12/089,955 (publ. no. US 2008/0250975)
Dean (2006) U.S. patent application Ser. No. 10/558,294 (publ. no. US 2006/0230981)

1. A bitumen cutback agent including lower alkyl esters of shorter chain length fatty acids.

2. A bitumen cutback agent as claimed in claim 1 wherein the shorter chain length fatty acids are predominantly C₆₋₁₄ fatty acids.

3. A bitumen cutback agent as claimed in claim 1 wherein the shorter chain length fatty acids are predominantly C₈₋₁₂ fatty acids.

4. A bitumen cutback agent as claimed in claim 1 wherein the lower alkyl esters of shorter chain length fatty acids are C₁₋₃ alkyl esters of shorter chain length fatty acids.

5. A bitumen cutback agent as claimed in claim 1 wherein the lower alkyl esters of shorter chain length fatty acids are methyl esters of shorter chain length fatty acids.

6. A bitumen cutback agent as claimed in claim 1 wherein the shorter chain length fatty acids are predominantly saturated fatty acids.

7. A bitumen cutback agent as claimed in claim 1 wherein the lower alkyl esters of shorter chain length fatty acids consist predominantly of methyl esters of the following formulae: CH₃(CH₂)₄COOCH₃; CH₃(CH₂)₆COOCH₃; CH₃ (CH₂)₈COOCH₃; CH₃(CH₂)₁₀COOCH₃, and CH₃(CH₂)₁₂COOCH₃.

8. A bitumen cutback agent as claimed in claim 1 wherein the lower alkyl esters of shorter chain length fatty acids consist predominantly of methyl esters of the following formulae: CH₃(CH₂)₆COOCH₈; CH₃(CH₂)₈COOCH₃; and CH₃(CH₂)₁₀COOCH₃.

9. A bitumen cutback agent as claimed in claim 1 the lower alkyl esters of shorter chain length fatty acids consist predominantly of methyl esters of the formulae CH₃(CH₂)₈COOCH₃ and CH₃(CH₂)₁₀COOCH₃.

10. A bitumen cutback agent as claimed in claim 1 wherein the lower alkyl esters of shorter chain length fatty acids consist predominantly of esters where the lower alkyl and fatty acid groups together comprise less than 16 carbon atoms.

11. A bitumen cutback agent as claimed in claim 1 wherein the lower alkyl esters of shorter chain length fatty acids consist predominantly of esters where the lower alkyl and fatty acid groups together comprise less than 15 carbon atoms.

12. A bitumen cutback agent as claimed in claim 1 wherein the lower alkyl esters of shorter chain length fatty acids consist predominantly of esters where the lower alkyl and fatty acid groups together comprise less than 14 carbon atoms.

13. A bitumen cutback agent as claimed in claim 1 wherein the lower alkyl esters of shorter chain length fatty acids are derived from non-mineral sources.

14. A bitumen cutback agent as claimed in claim 1 wherein the lower alkyl esters of shorter chain length fatty acids are derived from non-mineral plant sources.

15. A bitumen cutback agent as claimed in claim 1 wherein the lower alkyl esters of shorter chain length fatty acids are derived from coconut oil or palm kernel oil.

16. A bitumen cutback agent as claimed in claim 1 including esterified or transesterified coconut oil fatty acids or coconut oil fatty acid derivatives.

17. A bitumen cutback agent as claimed in claim 1 including esterified or transesterified palm kernel oil fatty acids or palm kernel oil fatty acid derivatives.

18. A bitumen cutback agent as claimed in claim 16 wherein the fatty acids are refined, or the esterified or transesterified fatty acids or fatty acid derivatives are refined, to reduce a level of esters of longer chain fatty acids in the cutback agent.

19. A method of bitumen seal coating, comprising:
providing a bitumen cutback agent as claimed in claim 1, and
performing bitumen seal coating using the bitumen cutback agent.

20. A method of cold mix application, comprising:
Providing a bitumen cutback agent as claimed in claim 1; and
performing cold mix application of the bitumen cutback agent.

21. A cutback bitumen composition including bitumen and a bitumen cutback agent as claimed in claim 1.

22. A method of temporarily reducing the viscosity of bitumen including the step of adding to bitumen a cutback agent according to claim 1.

23. A method of applying bitumen to a substrate including the steps of adding a bitumen cutback agent as claimed in claim 1 to the bitumen and applying the cutback bitumen to the substrate.

24. A method of forming a pavement surface including the steps of:
adding a bitumen cutback agent as claimed in claim 1 to bitumen;
applying the cutback bitumen to a substrate; and then
applying aggregate onto the cutback bitumen applied to the substrate.

25. Use of lower alkyl esters of shorter chain length fatty acids as bitumen cutback agents.

26. (canceled)
